(19) United States
(12) Patent Application Publication
(10) Pub. No.: US 2003/0112790 A1
(43) Pub. Date: Jun. 19, 2003

(54) Providing data link services to upper layer protocols in application and communication subsystems

(76) Inventors: Matthew A. Hayduk, Calgary (CA); Tim Daly, Calgary (CA)

Correspondence Address: Timothy N. Trop, TROP, PRUNER & HU, P.C., STE. 100, 8554 KATY FWY., HOUSTON, TX, 77024-1805, US

(21) Appl. No.: 10/024,088

(22) Filed: Dec. 17, 2001

(51) Int. Cl. H04J 3/24

(52) U.S. Cl. 370/349; 370/338

(57) ABSTRACT

A serial physical link may be provided that provides both isochronous and synchronous support by a software control. In addition, higher layer data link services may be provided over a serial physical link.

### BACKGROUND

This invention relates generally to communication systems and particularly to cellular telephones that include both baseband and applications processors.

In many cellular telephones, two different processors may be provided. The baseband processor may be responsible for implementing the cellular protocol that is followed by the particular handset. The applications processor provides network-based communications applications that utilize the baseband processor's corresponding services. Examples of applications that the applications processor may execute include calendars, browsers, and short message service (SMS) applications.

In some cases, the baseband processor and applications processor may be separate integrated circuits. In other cases, the two processors may be integrated in the same integrated circuit. In any case, the two processors may communicate with one another. Over time, the baseband processor may evolve differently than the applications processor. As the hardware changes, the ability to communicate with existing software may become more awkward.

Thus, there is a need for a way to enable the higher layer application software to operate relatively independently of the nature of the hardware. As a result, every time the hardware changes, it may not be necessary to change all of the software layer protocols.

In addition, there is always a need for higher bandwidth channel capabilities to meet growing cellular systems' bandwidth needs. It would be desirable to be able to scale channel capabilities with those growing needs.

### BRIEF DESCRIPTION OF THE DRAWINGS

FIG. 1 is a schematic depiction of one embodiment of the present invention;

FIG. 2 is a schematic depiction of another embodiment of the present invention;

FIG. 3 is a schematic depiction of the establishment of a data link connection in one embodiment;

FIG. 4 is a depiction of the use of basic service primitives in accordance with one embodiment of the present invention;

FIG. 5 is a schematic depiction of a channel mapping scheme in accordance with one embodiment of the present invention;

FIG. 6 is a schematic depiction of a channel mapping scheme in accordance with one embodiment of the present invention; and

FIG. 7 is a schematic depiction of still another channel mapping scheme in accordance with one embodiment of the present invention.

### DETAILED DESCRIPTION

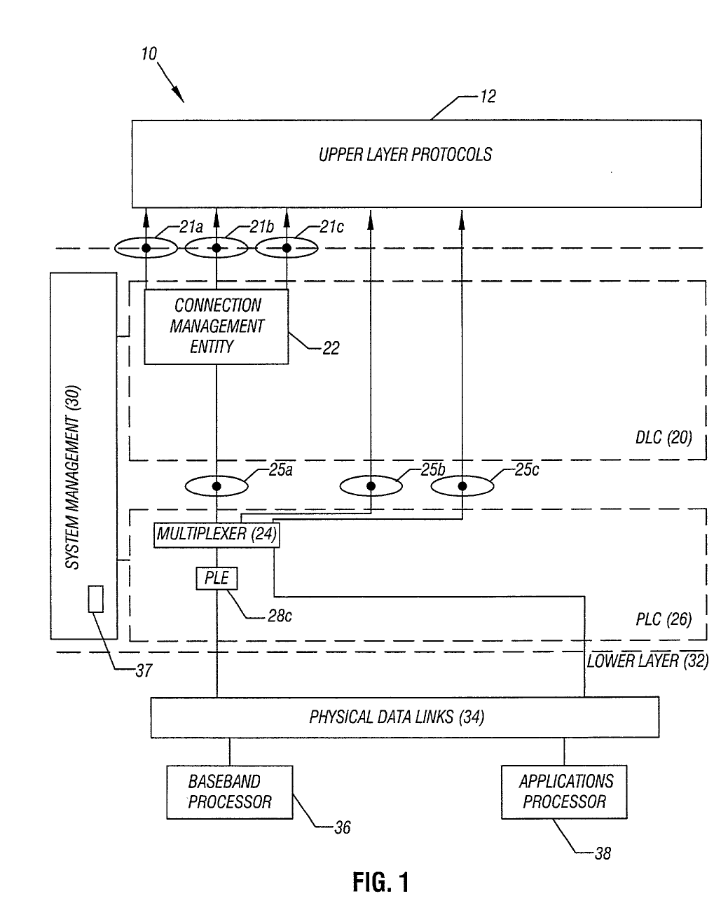

Referring to FIG. 1, the software interface 10 includes upper layer protocols 12 in accordance with one embodiment of the present invention. The upper layer protocols 12 may be protocols that need to access different hardware such as the baseband processor 36 or the applications processor 38 in one example. Examples of such protocols may include a remote procedure call (RPC) that links two or more processors. Another application is a streaming protocol to bind a source on one node to a sink on another node before asynchronous or isochronous data transfer.

The upper layer protocols 12 each have their own assigned service access point (SAP) 21. Thus, communications from the upper layer protocol 12 to any other entity proceeds through an assigned service access point 21. The service access point 21 has a unique service access point identifier (SAPI) so that the service access point 21 may be addressed and referenced.

A connection management entity (CME) 22 is the upper most layer of a data link control (DLC) 20. The connection management entity 22 manages the interface to the upper layer protocol 12, provides data buffering and queuing into the physical layer control 26 and manages the type of data transfer, associated with the logical link, over the data link, such as acknowledged or unacknowledged modes.

The data link control 20 provides point to point logical connections or channels and protocols. The data link control 20 also implements procedures for transferring of information and control at any peer service access point 21 between the communication subsystem (including the baseband processor 36) and application subsystem (including the applications processor 38). The data link control 20 provides support for transfers independently of any particular physical link. Multiple simultaneous connections may be implemented by one or more upper layer protocols 12.

Supporting the data link control 20 is the multiplexer 24 and physical layer entities (PLEs) 28 of the physical link control (PLC) 26. The DLC 20 and the PLC 26 are linked by channel end points 25.

Information is transferred between peer entities in the form of protocol data units (PDUs). The PDUs of the N+1 layer peer-to-peer protocol are transferred by the N layer protocol in the form of service data units. The service data unit is a part of the payload of the PDU of the N layer protocol.

The actual physical links are below the middle layer and the lower layer 32. The physical data links 34 may connect a baseband processor 36 and an applications processor 38 in one embodiment.

The system management 30 may be responsible for establishing channels, controlling protocol data units (PDUs) having higher priority, reporting errors, and managing channel end point identifiers (CEIs). Each channel includes an end point (CE) which may be identified by a channel end point identifier (CEI). Thus any channel may be identified by its pair of opposed channel end point identifiers.

In some cases, additional channels may be provided for asynchronous transfers as indicated by the channel end point 25b and for synchronous transfers as indicated by the channel end point 25c.

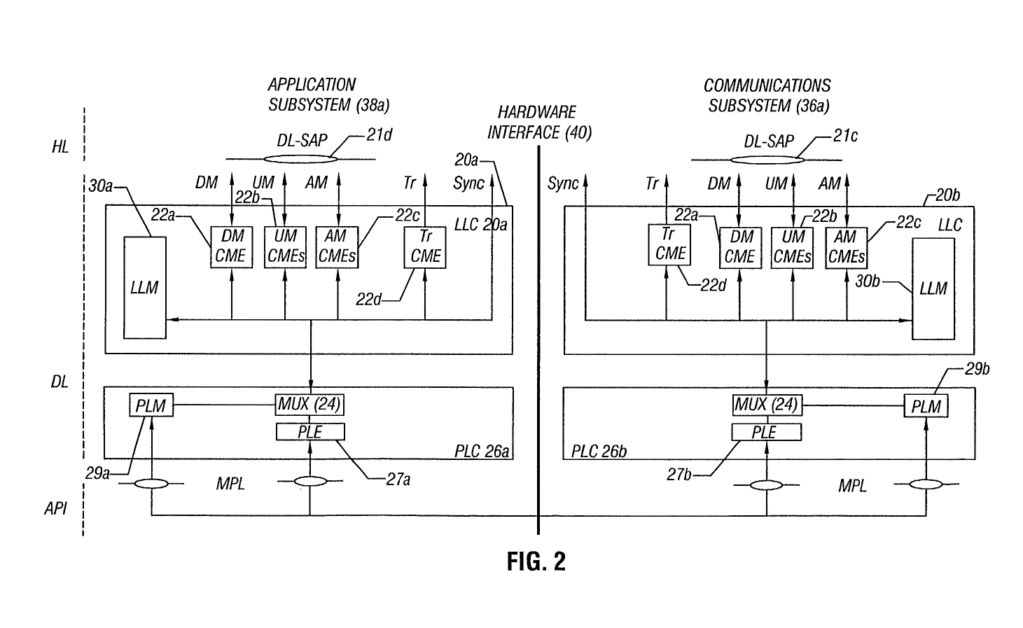

Referring to FIG. 2, in accordance with another embodiment of the present invention, an applications subsystem 38a may communicate across a hardware interface 40 with a communications subsystem 36a. The applications subsystem 38a may include the applications processor (not shown) and the communications subsystem 36a may include a baseband processor (not shown).

The upper layer or higher layer protocol (HL) may communicate with the data layer (DL) through a data layer service access point (DL-SAP) 21d. The data layer may include a logical link control (LLC) 20a that includes a logical link manager 30a (corresponding to the system management 30 in the embodiment of FIG. 1), a multiplexer 24 (as described previously) and a plurality of connection management entities (CMEs) 22.

The datagram mode connection management entity (DM CME) 22a provides datagram mode data transfer. It provides connection-less datagram data transfer between the higher layer (HL) and the data layer (DL).

The unacknowledged mode data transfer connection management entities (UM CMES) 22b are automatically assigned a CEI 25a during the channel setup. The CEI 25a is returned when the channel is released. The UM CMEs 22b implement connection oriented data transmission through a logical data link connection or higher layer protocol data units (PDUs).

Thus, the unacknowledged mode (UM) data transfer involves connection oriented data transmission for higher layer PDUs with flow control and no recovery of lost or damaged PDUs. The datagram mode (DM), in contrast, includes immediate, connection-less data transmission for higher layer PDUs without flow control, without guaranteed delivery and without recovery of damaged or lost PDUs.

The acknowledged mode data transfer connection management entities (AM CMEs) 22c implement an acknowledged data transfer mode (AM). AM is a guaranteed, connection oriented data transmission for higher layer PDUs. With AM, receipt is acknowledged to the higher layers. The AM CMEs 22c use dynamically assigned CEIs 25a. The CEIs 25a are dynamically assigned by the local layer management entity 30a. The CEIs 25a are returned when the channels are released.

The multiplexer 24 multiplexes PDUs for multiple CMEs for data transmission through the physical layer entity. Data headed for physical links are queued for transmission based on their assigned quality of service. The multiplexer 24 is placed in the PLC 26, in one embodiment, since quality of service and reliability are inherent to the hardware. This placement also provides better separation between the LLC 20 and PLC 26.

Data traffic may be classified based on its characteristics and on the desired quality of service. In a conversational class, two-way real time conversational audio or video data may be involved. The fundamental requirements for conversational traffic are driven by human perception. Conversational data may use a two-way communication channel with low end-to-end transfer delay and low delay variation.

The streaming class involves one-way real time audio or video data. The fundamental requirement for streaming traffic is driven by human perception. Streaming traffic involves a one-way communication channel with low end-to-end delay variation. Because the communication channel is a one way channel it does not have the same low transfer delay requirements of a conversational traffic class.

An interactive class involves request/response communications between end users. The end users in the communication may be human or machine. Examples of human interaction are web browsing and database retrieval. An example of machine-to-machine interaction is a database query between an automated banking machine and a database. Important attributes of the interactive class are round trip delay and low error rates.

Finally, the background class involves asynchronous communications between end users. The destination end user is not expecting the data at a certain time. Traffic is classified as background traffic if it is less time sensitive than other traffic types. Examples of this traffic class are electronic mail, simple message service (SMS) and database downloads.

Still another transfer mode is the transparent (Tr) mode data transfer using the CEI 25b. The transparent (Tr) mode data transfer is connection-oriented isochronous data transfer. An example of a Tr mode data transfer is audio streaming. Finally, the synchronous (Sync) mode data transfer may be provided through the CEI 25c.

The PLC 26a includes a plurality of PLEs 27a and a PLM 29a. The PLM 29a controls the PLEs 27a. The PLC 26a enables the LLC 20a to control the physical links (PL). The PLC 26a also provides transport for asynchronous and isochronous data transfers over the CEIs 25b and 25c.

The LLM 30a establishes the UM and AM channels. The LLM 30a also manages the CEIs 25. The multiplexer 24 controls PDUs priority and physical layer routing. The multiplexer 24 allocates physical layer bandwidth appropriately to meet the required level of service. The multiplexer 24 also reports any errors to a higher layer (HL).

In accordance with some embodiments of the present invention, functionality can move across processors or physical communication interfaces may change without affecting the software for the data link layers. This is due to the fact that the PLC 26 handles this dependency, allowing the LLC 20 and the higher layers to move freely. The abstract layer of the service primitive hides these physical dependencies.

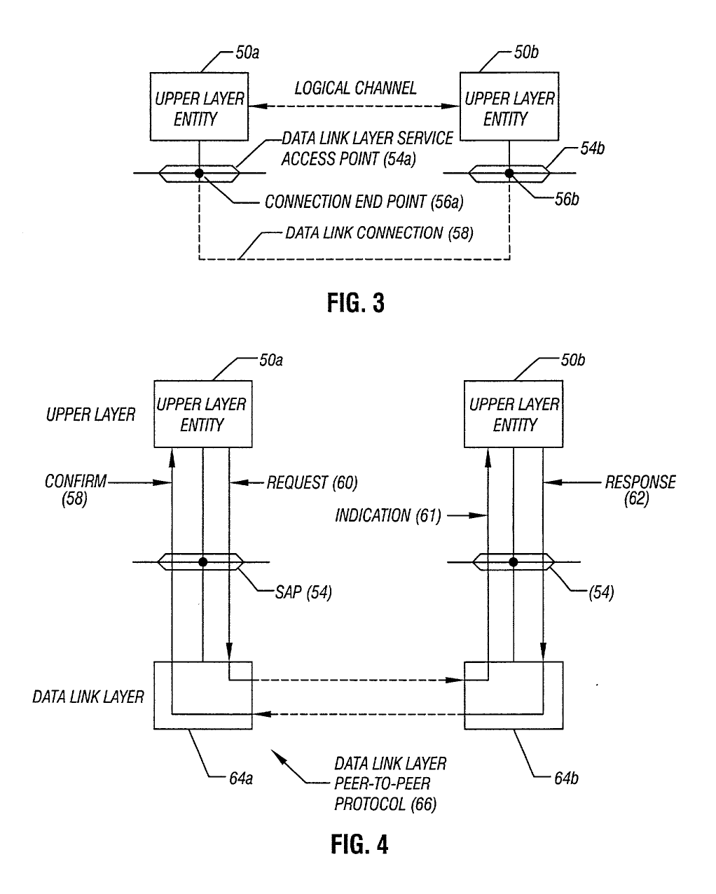

Referring to FIG. 3, an upper layer entity 50a may be coupled through a data link layer service access point 54a and a connection endpoint 56a to a data link connection 58a. An upper layer 50b is coupled through a service access point 54b and an endpoint 56b.

The upper layer entity 50 accesses data link services through a data link service access point 54. Each upper layer entity 50 has its own service access point 54 and is identified by a unique service access point identifier. Each endpoint 56 of a data link connection 58 is identified by a channel endpoint identifier that is assigned when the data link connection 58 is established. Thus, the channel endpoint identifier is visible from the upper layer entity 50. Referring to FIG. 4, the upper layer entities 50a and 50b may communicate using basic service primitives. The data link layer 64a associated with the upper layer entity 50a and the data link layer 64b associated with the upper layer entity 50b provide data link layer peer-to-peer protocols.

Initially, a request indication 60 may come from an upper layer entity 50a that requests service from a lower layer. An indication 61 is used by a layer providing the service to notify the next higher layer of any specific activity that is related to that service. A confirm 58 may be used by a layer providing the requested service to confirm that the activity has been completed. The response 62 is used by a layer to acknowledge receipt of a primitive indication from a lower layer.

Through the use of the service primitives, hardware changes may be made without requiring software changes in some embodiments. In other words, the service primitives abstract the operation to a sufficient degree that the software may be relatively independent of the physical layer.

The actual mapping of the logical layer to the hardware layer may be based on a number of considerations including quality of service priorities. For example, the different classes of service, such as conversational class, streaming class, system signaling, interactive class and background class may be implemented through schemes for channel mapping that emphasize different aspects to achieve a desired level of service. In addition, the nature of the cellular system may determine the type of channel mapping that is utilized, as may the architecture of the individual cellular handsets.

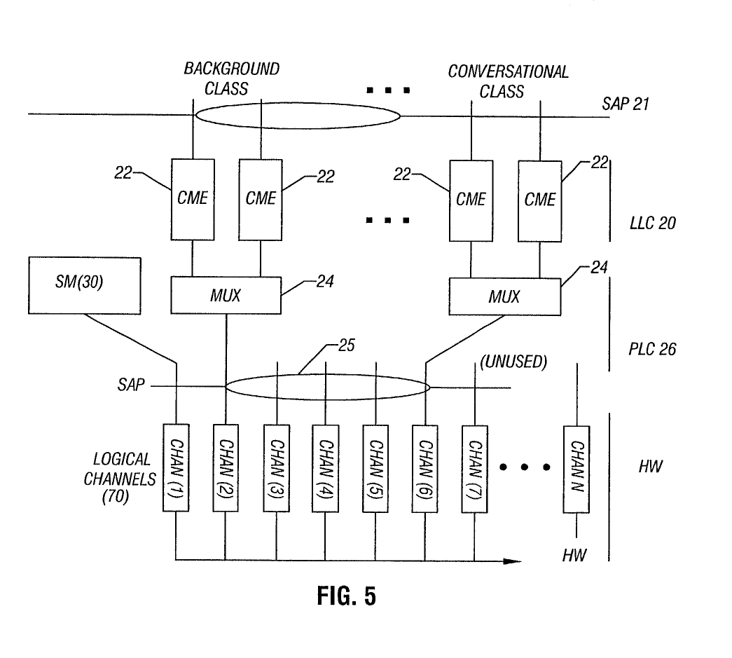

In accordance with one embodiment of the present invention, shown in FIG. 5, each priority class, such as the background class and the conversational class, has its own channel. The logical channels are multiplexed with the same priority in round robin fashion. A logical channel 70 may be assigned to each class. For example, channel 2 may be assigned to the background class and channel 6 may be assigned to the conversational class.

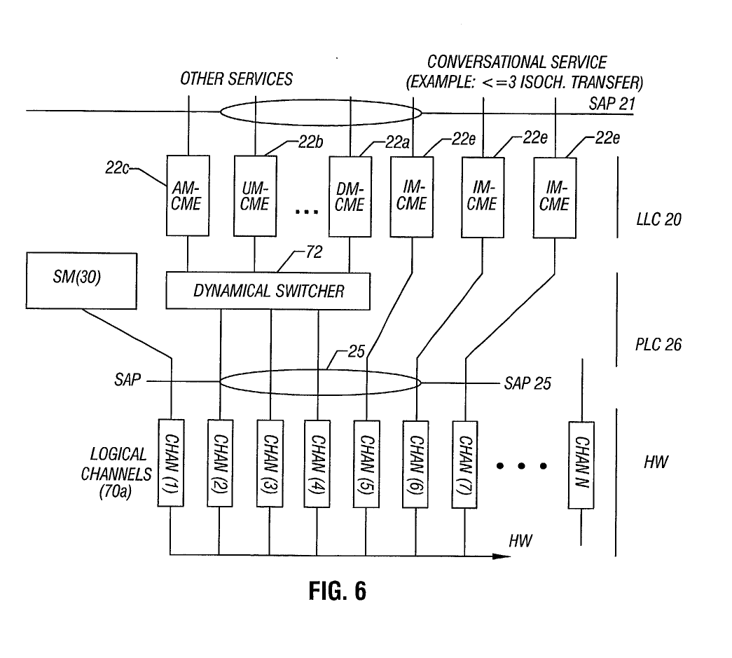

Referring to FIG. 6, in this embodiment, one channel (channel 1) is provided for management, three channels (channels 5-7) are provided for the conversational class and the rest of the channels are dynamically assigned using a dynamical switcher 72 on a first come, first served fashion. A channel 70a is released for other logical channels when the current data transfer is complete. The channel mapping may be optimized for a particular hardware such as direct memory access and may provide limited isochronous transfer paths.

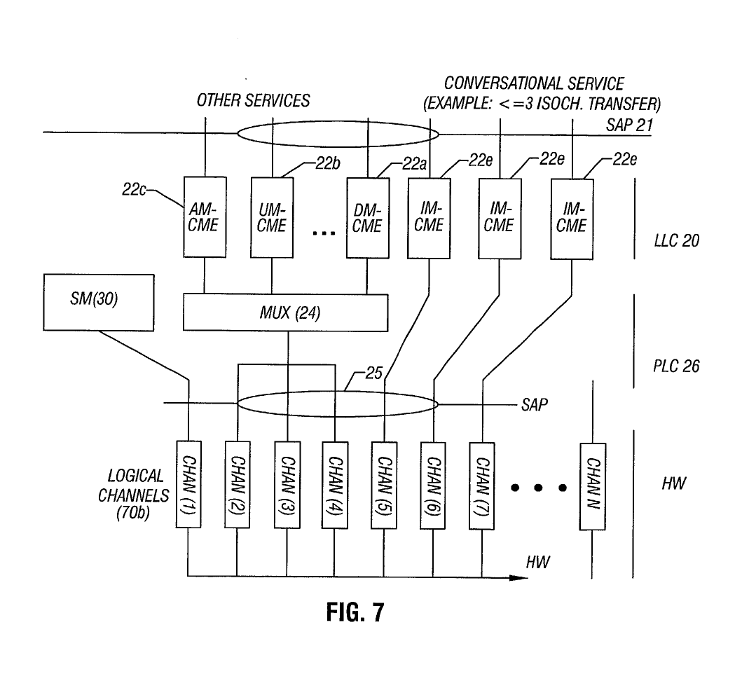

Referring to FIG. 7, still another embodiment uses one channel for the system manager 30. Conversational service is provided on three channels and the remaining services are multiplexed over the channels 2, 3 and 4.

The system may allow considerable flexibility in adjusting to the various quality of service, system requirement, handset architecture and performance needs in some embodiments. Thus, a high bandwidth channel capability may be able to scale with cellular system bandwidth growth. Because the LLC 20 and PLC 20 are separated, added flexibility may be achieved in allocating the interaction with the channels to deal with a wide range of service capabilities, in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
establishing a serial physical link; and
providing isochronous support by a software control on the serial physical link.

2. The method of claim 1 further including providing synchronous support by a software control on the serial physical link.

3. The method of claim 1 further including providing asynchronous support by a software control on the serial physical link.

4. The method of claim 1 further including providing separate logical and physical layers.

5. The method of claim 4 including providing a multiplexer in the physical layer coupled to the logical layer.

6. The method of claim 5 including coupling a baseband processor to said physical layer.

7. The method of claim 5 including coupling an applications processor to said physical layer.

8. The method of claim 1 including providing a plurality of different channel mapping schemes and enabling the selection of one of said schemes.

9. The method of claim 8 including providing a channel mapping scheme in which each of a plurality of classes has its own channel and multiplexing logical channels with the same priority in round robin fashion.

10. The method of claim 8 including dynamically assigning channels on a first come, first served basis.

11. The method of claim 8 including assigning a plurality of channels to conversational service and providing a plurality of multiplexed channels for other services.

12. An article comprising a medium storing instructions that enable a processor-based system to:
establish a serial physical link; and
provide isochronous support by a software control on the serial physical link.

13. The article of claim 12 further storing instructions that enable a processor-based system to provide synchronous support by a software control on the serial physical link.

14. The article of claim 12 further storing instructions that enable a processor-based system to provide a plurality of different channel mapping schemes and enable the selection of one of said schemes.

15. The article of claim 14 further storing instructions that enable a processor-based system to provide a channel mapping scheme in which each of a plurality of classes has its own channel and multiplex logical channels with the same priority in round robin fashion.

16. The article of claim 14 further storing instructions that enable a processor-based system to dynamically assign channels on a first come, first served basis.

17. The article of claim 14 further storing instructions that enable a processor-based system to assign a plurality of channels to conversational service and provide a plurality of multiplexed channels for other services.

18. An apparatus comprising:
a serial physical link that provides isochronous support by a software control on the serial physical link; and
a logical layer control to interface with said physical link.

19. The apparatus of claim 18 wherein said link provides asynchronous support by a software control on the serial physical link.

20. The apparatus claim 19 wherein said link provides synchronous support by a software control on the serial physical link.

21. The apparatus of claim 19 wherein said physical layer control is coupled to said logical layer control.

22. The apparatus of claim 21 wherein said physical layer control includes a multiplexer coupled to the logical layer control.

23. The apparatus of claim 22 including a baseband processor coupled to said physical layer control.

24. The apparatus of claim 22 including an applications processor coupled to said physical layer control.

25. The apparatus of claim 19 including a control to provide a plurality of different channel mapping schemes and enable the selection of one of said schemes.

26. The apparatus of claim 25 including a control to provide a channel mapping scheme in which each of a plurality of classes has its own channel and to multiplex logical channels with the same priority in round robin fashion.

27. The apparatus of claim 25 including a control to dynamically assign channels on a first come, first served basis.

28. The apparatus of claim 25 including a control to assign a plurality of channels to conversational service and to provide a plurality of multiplexed channels for other services.
